(19) United States
(12) Patent Application Publication
(10) Pub. No.: US 2005/0050286 A1
(43) Pub. Date: Mar. 3, 2005

(54) Apparatus and method for asynchronous logical mirroring

(75) Inventors: Thomas Richard Crowley, Rochester, MN (US); Robert Thaddeus Gintowt, Rochester, MN (US); Kevin Curtis Griffin, Rochester, MN (US); Scott Dennis Helt, Rochester, MN (US); Glen Warren Nelson, Rochester, MN (US); Mark Philip Piazza, Rochester, MN (US)

Correspondence Address: MARTIN & ASSOCIATES, LLC;IBM INTELLECTUAL PROPERTY LAW DEPARTMENT, DEPARTMENT 917, BUILDING 006-1, 3605 HIGHWAY 52 NORTH, ROCHESTER, MN, 55901-7829, US

(73) Assignee: INTERNATIONAL BUSINES MACHINES CORPORATION, ARMONK, NY (US)

(21) Appl. No.: 10/651,149

(22) Filed: Aug. 28, 2003

(51) Int. Cl. G06F 12/16

(52) U.S. Cl. 711/162

(57) ABSTRACT

An apparatus and method provides the capability of mirroring storage between geographically remote locations in an asynchronous manner that does not require all writes on primary storage to be performed in the same order on the mirrored storage. The mirroring of the present invention is “logical mirroring”, which does not require identical disk drives, and which supports mirroring between geographically remote locations to protect against catastrophic site failure. A sequence number is assigned to data written to primary storage before the data is transferred to the mirrored storage. The mirrored storage can write data asynchronously, which may result in some data being written before previous data on the mirrored storage. When a system failure occurs that requires use of the mirrored storage, the mirrored storage is first quiesced to allow all pending writes to occur. If the mirrored storage has no missing data corresponding to a sequence number that is lower than the highest sequence number of data written to the mirrored storage, the mirrored storage may be used. If, however, the mirrored storage has missing data corresponding to a sequence number that is lower than the highest sequence number of data written to the mirrored storage, the mirrored storage cannot be used.

### BACKGROUND OF THE INVENTION

1. Technical Field

This invention generally relates to data processing, and more specifically relates to the mirroring of storage in a computer system.

2. Background Art

Since the dawn of the computer age, computer systems have evolved into extremely sophisticated devices that may be found in many different settings. Many computer systems include critical data that must not be lost if a failure in the computer system occurs. In the prior art, the concept of “mirroring” is known. Two identical disk drives are typically installed on a computer system. One is designated primary storage, while the other is designated mirrored storage. For each write to the primary storage disk drive, a corresponding write of the same data to the same physical location is made to the mirrored storage disk drive. Thus, the mirrored storage becomes a “mirror image” of the primary storage. Should the primary storage fail, the mirrored storage could then be used, because the mirrored storage contains the same data in the same physical locations as the primary storage.

A prior art method 200 for local (or physical) mirroring is shown in FIG. 2. Identical disk drives are provided (step 210). Data is written to primary storage (step 220). The data written to primary storage is then copied to the same physical location on the mirrored storage (step 230). In this manner, the mirrored storage is an exact copy, down to the sector level, of the primary storage. Such a system 300 is shown in block diagram form in FIG. 3. The computer system 300 includes primary storage 310 and mirrored storage 320 that are identical disk drives. When data is written to primary storage 310, the data is then copied to the same physical location on mirrored storage 320.

Two problems exist with the local mirroring as shown in FIGS. 2 and 3. First, local mirroring requires identical disk drives. Thus, if the primary storage disk drive is upgraded, the mirrored storage disk drive must be likewise upgraded. Second, local mirroring requires that these identical drives be on the same computer system (e.g., 300 in FIG. 3). While it may be possible to achieve some degree of physical separation between primary storage and mirrored storage within the same computer system, the local mirroring still requires that the primary and mirrored storage be on the same computer system. A catastrophic event at a site (e.g., earthquake, fire, etc.) could easily result in destruction of both the primary storage and the mirrored storage. For this reason, local mirroring is not a suitable protection against catastrophic site failure. Without a way to provide mirroring of storage that spans a large distance, the computer industry will continue to suffer from inadequate ways of protecting against catastrophic site failures.

### Disclosure of Invention

An apparatus and method provides the capability of mirroring storage between geographically remote locations in an asynchronous manner that does not require all writes on primary storage to be performed in the same order on the mirrored storage. The mirroring of the present invention is “logical mirroring”, which does not require identical disk drives, and which supports mirroring between geographically remote locations to protect against catastrophic site failure. A sequence number is assigned to data written to primary storage before the data is transferred to the mirrored storage. The mirrored storage can write data asynchronously, which may result in some data being written before previous data on the mirrored storage. When a system failure occurs that requires use of the mirrored storage, the mirrored storage is first quiesced to allow all pending writes to occur. If the mirrored storage has no missing data corresponding to a sequence number that is lower than the highest sequence number of data written to the mirrored storage, the mirrored storage may be used. If, however, the mirrored storage has missing data corresponding to a sequence number that is lower than the highest sequence number of data written to the mirrored storage, the mirrored storage cannot be used.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a computer apparatus in accordance with the preferred embodiments;

FIG. 2 is a flow diagram of a prior art method for local mirroring;

FIG. 3 is a block diagram of a prior art computer system that performs local mirroring;

FIG. 4 is a flow diagram of a method for performing asynchronous logical mirroring in accordance with the preferred embodiments;

FIG. 5 is a block diagram of a computer system that supports asynchronous logical mirroring in accordance with the preferred embodiments;

FIG. 6 is a flow diagram of a method for using mirrored storage in accordance with the preferred embodiments;

FIG. 7 is a block diagram showing mirrored storage that does not contain any missing data;

FIG. 8 is a block diagram showing mirrored storage that contains missing data below the highest written sequence number; and

FIG. 9 is a block diagram showing mirrored storage that contains less data than primary storage but is still usable because all data below the highest sequence number has been written.

### BEST MODE FOR CARRYING OUT THE INVENTION

The preferred embodiments provide a way to logically mirror storage across geographically remote locations. By assigning a sequence number to data written to primary storage before it is written to mirrored storage, the logical mirroring mechanism can determine whether all data writes have occurred. If so, the mirrored storage may be used. If not, the mirrored storage cannot be used because it has missing data.

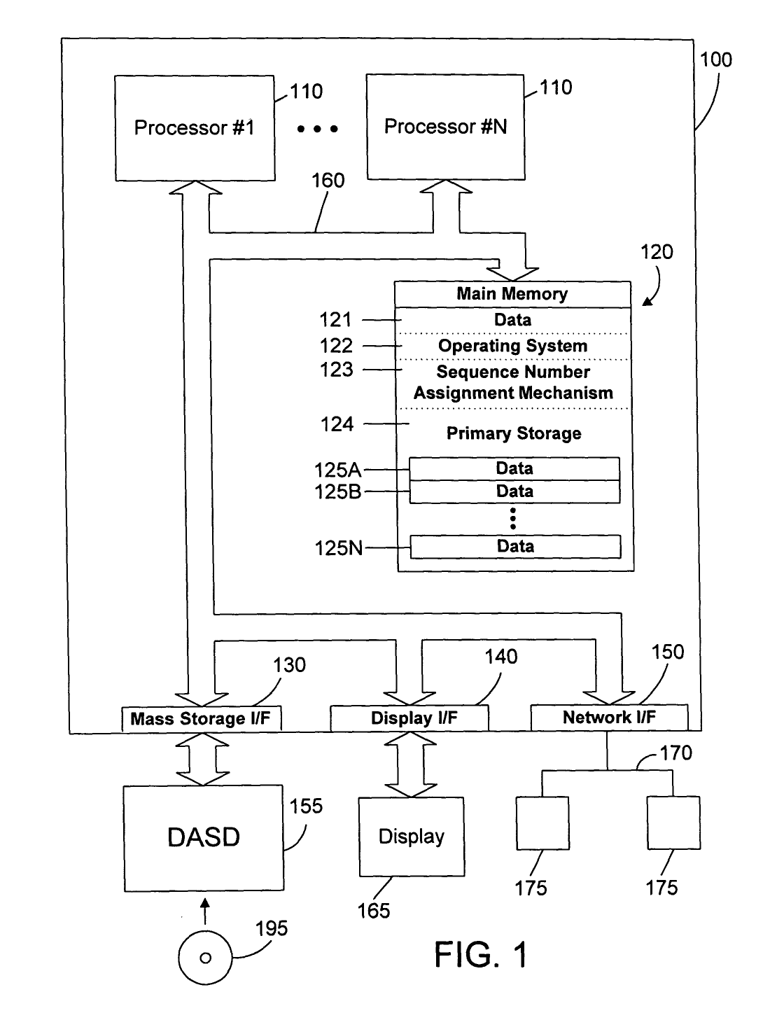

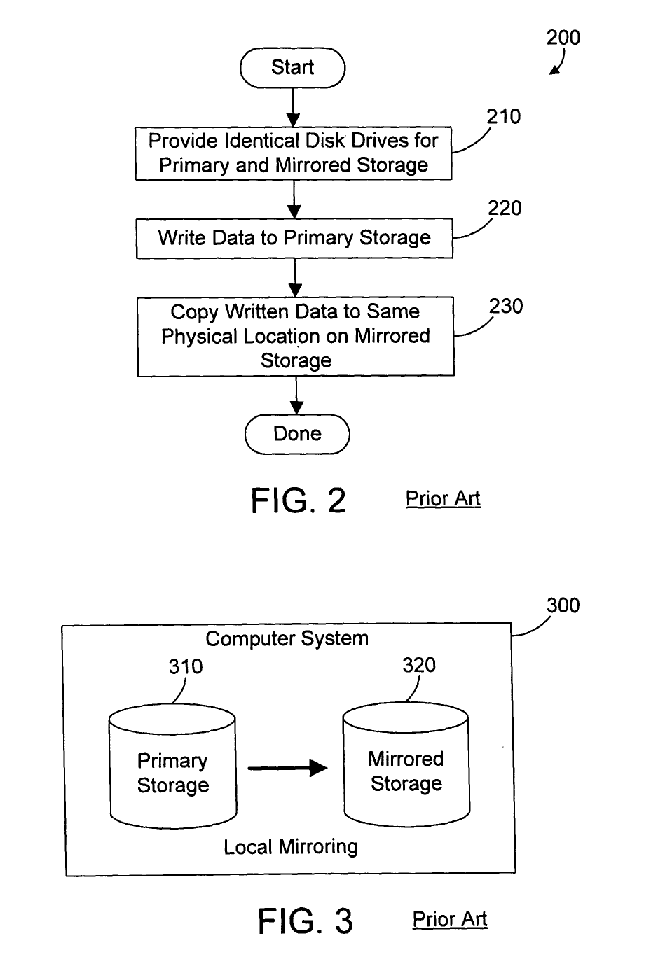

Referring to FIG. 1, a computer system 100 is an enhanced IBM eServer iSeries computer system, and represents one suitable type of computer system in accordance with the preferred embodiments. Those skilled in the art will appreciate that the mechanisms and apparatus of the present invention apply equally to any computer system. As shown in FIG. 1, computer system 100 comprises one or more processors 110 connected to a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device is a CD RW drive, which may read data from a CD RW 195.

Main memory 120 contains data 121, an operating system 122, a sequence number assignment mechanism 123, and primary storage 124. Data 121 is any data that may be read or written by any processor 110 or any other device that may access the main memory 120. Operating system 122 is a multitasking operating system, such as OS/400, AIX, or Linux; however, those skilled in the art will appreciate that the spirit and scope of the present invention is not limited to any one operating system. Any suitable operating system may be used. Operating system 122 is a sophisticated program that contains low-level code to manage the resources of computer system 100. Some of these resources are processor 110, main memory 120, mass storage interface 130, display interface 140, network interface 150, and system bus 160.

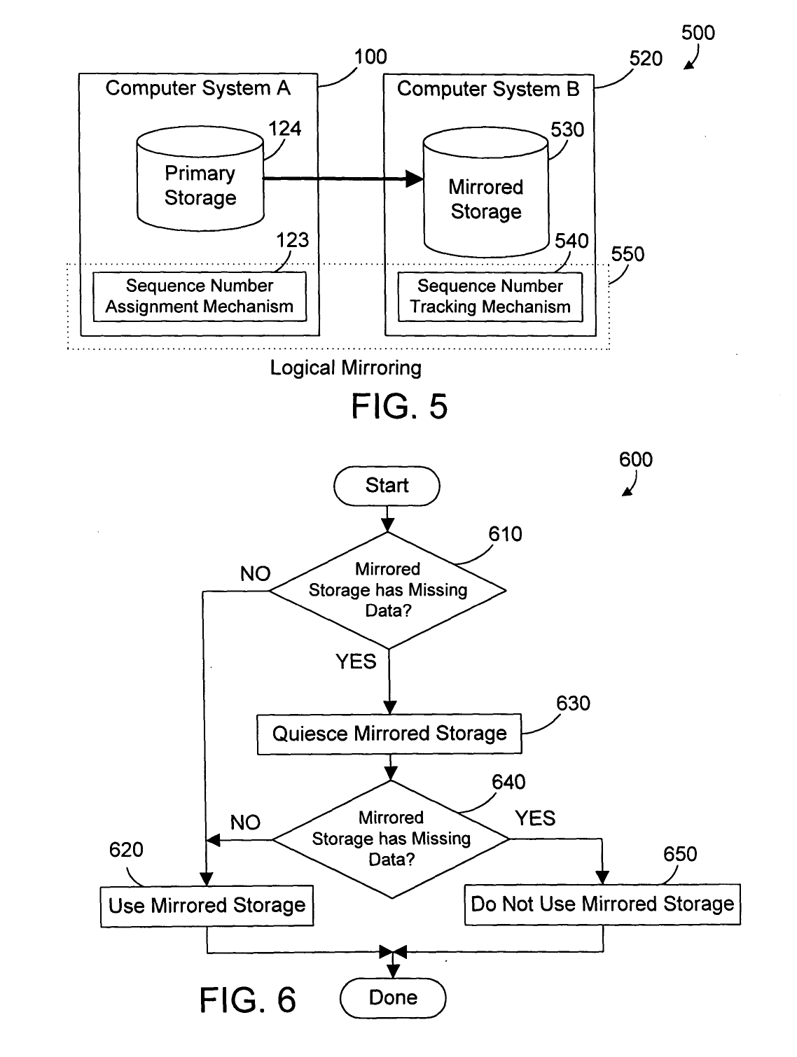

Note that the presence of sequence number assignment mechanism 123 and primary storage 124 means that computer system 100 corresponds to a primary computer system, where the data is initially written to the primary storage 124 and which transfers the data and assigned sequence number to a target system that includes mirrored storage. Note, however, that the computer system 100 could also be used as the target computer system if the primary storage 124 is replaced with mirrored storage, and if the sequence number assignment mechanism 123 is replaced with a sequence number tracking mechanism, as discussed below with reference to FIG. 5.

Sequence number assignment mechanism 123 assigns sequence numbers to data that needs to be written to primary storage 124. The data is then written to primary storage 124, and the data and corresponding sequence number are transferred to the target system that includes the mirrored storage (see FIG. 5). Sequence numbers in the preferred embodiments are sequential integers. Each entry 125 in the primary storage 124 is preferably assigned a sequence number before the data is written to primary storage. Thus, for the example shown in FIG. 1, data corresponding to each entry 125A, 125B, . . . , 125N in primary storage will be assigned a sequence number before the data entry is written to primary storage 124 and before the data entry is written to mirrored storage. Note that primary storage 124 in main memory 120 is representative of a large datastore. DASD 155 is one suitable example of a datastore that could serve as primary storage 124.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, sequence number assignment mechanism 123, and primary storage 124 are shown to reside in main memory 120, those skilled in the art will recognize that these items are not necessarily all completely contained in main memory 120 at the same time. It should also be noted that the term “memory” is used herein to generically refer to the entire virtual memory of computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up the operating system 122.

Although computer system 100 is shown to contain only a single system bus, those skilled in the art will appreciate that the present invention may be practiced using a computer system that has multiple buses. In addition, the I/O interfaces that are used in the preferred embodiment each may include separate, fully programmed microprocessors that are used to off-load compute-intensive processing from processor 110, as in iSeries input/output processors, or may be simple industry standard I/O adapters (IOAs).

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer readable signal bearing media used to actually carry out the distribution. Examples of suitable signal bearing media include: recordable type media such as floppy disks and CD RW (e.g., 195 of FIG. 1), and transmission type media such as digital and analog communications links.

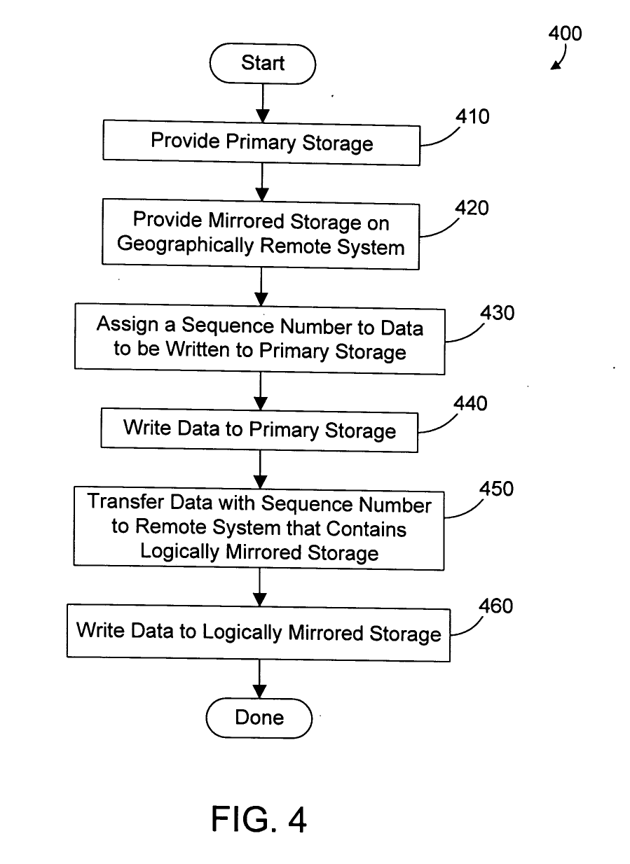

Referring now to FIG. 4, a method 400 in accordance with the preferred embodiments allows logical mirroring of primary storage in an asynchronous manner on the target computer system that includes the mirrored storage. Method 400 begins by providing the primary storage (step 410) and providing mirrored storage on a geographically remote system (step 420). One significant advantage of the logical mirroring of the preferred embodiments is that the primary storage and mirrored storage need not be identical disk drives. The mirrored storage may be any arrangement and configuration of one or more drives that provides at least the capacity of the primary storage. Note that the term “geographically remote” is not used herein to denote any minimum distance between the primary storage and the mirrored storage, but is used to broadly represent any geographic separation of the primary storage from the mirrored storage. In the most preferred implementation, the primary storage and the mirrored storage are in separate buildings. This configuration allows the mirrored storage to survive if a catastrophe destroys the building in which the primary storage is housed but leaves the building with the mirrored storage intact. However, the preferred embodiments expressly extend to any suitable degree of geographic separation between primary storage and mirrored storage, from separation of a few inches to separation of hundreds or thousands of miles. By allowing logical mirroring to a system that is a substantial distance from the primary storage, the likelihood that a catastrophe that affects the primary storage would also affect the mirrored storage is reduced.

Method 400 assigns a sequence number to data to be written to primary storage (step 430). The data is then written to primary storage (step 440). The data with its assigned sequence number is also transferred to the geographically remote system that contains the logically mirrored storage (step 450). Note that steps 440 and 450 are preferably performed in parallel. The data is then written to the logically mirrored storage (step 460). Note that the writing of the received data to the logically mirrored storage is done in an asynchronous manner so multiple tasks may service the incoming data without the need for assuring one task completes a write before a different task performs its write.

A networked computer system 500 in accordance with the preferred embodiments is shown in FIG. 5 to preferably include two separate computer systems 100 and 520 that are located in locations that are geographically remote from each other. Thus, the sequence number assignment mechanism 123 on computer system 100 (see FIG. 1) assigns sequence numbers to data stored on the primary storage 124, the data and assigned sequence numbers are then transferred via network to the second computer system 520, and the data is then written to the mirrored storage 530. A sequence number tracking mechanism 540 on the target system 520 tracks the sequence numbers written to assure the mirrored storage may be used when needed. This type of mirroring is “logical” rather than the “physical mirroring” known in the prior art because the primary storage and mirrored storage can be different sizes and types of disk drives. This is represented graphically in FIG. 5 by the mirrored storage 530 being larger than the primary storage 124. When an object needs to be written to primary storage, memory is allocated on the primary storage that is sufficient to contain the object. The object is then written to the allocated pages on the primary storage. The space for the same number of pages is then allocated on the mirrored storage 530, and the data is then written to the mirrored storage 530. In the most preferred embodiments, the sequence number is not written to the primary storage 124 and is not written to the mirrored storage 530. The sequence numbers are tracked by the sequence number tracking mechanism 540 to determine whether the mirrored storage is usable when use of the mirrored storage is required. Note that the combination of the sequence number assignment mechanism 124 on the primary system 100 and the sequence number tracking mechanism 540 on the target system 520 together make up a logical mirroring mechanism 550 in accordance with the preferred embodiments, as shown by the dotted box in FIG. 5. Note further that an “apparatus” within the scope of the preferred embodiments and claims herein includes multiple computer systems (such as a primary system and a target system) that collectively perform the function of the logical mirroring mechanism 550.

An object on the primary storage 124 could span multiple disk drives in mirrored storage 530. This is why the mirroring of the preferred embodiments is referred to as “logical mirroring”. All objects located on the primary storage are written to the mirrored storage, but there is no physical relationship between where these objects are stored on the primary and mirrored storage.

One feature of the logical mirroring of the preferred embodiments is that writes to the mirrored storage may occur asynchronously for different pages, even if the data in one page depends on data in a different page. This means that the sequence of data written to the primary storage is not necessarily preserved on the mirrored storage. For example, if data with sequence numbers 11, 12 and 13 are written to the primary storage and transferred to the target system that includes the mirrored storage, the order of writes to the mirrored storage on the target system could be 11, 13, 12. One way to assure the mirrored storage can be used when needed would be to enforce the order of writes to the mirrored storage to be the same as the order of writes to the primary storage. Synchronizing the order of writes significantly adds to the system overhead in performing the mirroring, thereby increasing the time required to write mirrored data when compared to asynchronous writes. An example of synchronous updates will illustrate the overhead required to synchronize writes to the mirrored storage. Let's assume on primary storage that page A is updated and written and then page B is updated and written and is dependent on the data in page A. If the order of writes on the primary storage is enforced on the mirrored storage, the mirrored storage must write A and send an acknowledgment of the write of A before page B may be written to primary storage. This guarantees that the mirrored storage never sees the update to B unless the update to A is also there. However, doing these steps synchronously causes the task writing to primary storage to 1) wait for A to get written to primary storage; 2) wait for the message to get sent to the mirrored storage; 3) wait for A to be written to mirrored storage; and 4) wait for the acknowledgment from the mirrored storage that A has been written. At this point, B may be written to primary storage. This type of synchronous processing of updates is very slow, but the mirrored storage is guaranteed to be usable after any crash because all updates to the mirrored storage are done in the same order as the updates to the primary storage. Due to the large performance penalty in performing mirroring in a synchronous fashion, asynchronous writes to mirrored storage are preferred. However, because asynchronous writes may result in missing data, there must be a way to determine whether the mirrored storage is usable when needed.

Referring now to FIG. 6, a method 600 in accordance with the preferred embodiments determines whether the mirrored storage may be used when required (such as after a power outage or crash of the primary storage). First, the mirrored storage is examined for missing data (step 610). Data is missing in the mirrored storage if data corresponding to a sequence number that is less than the highest sequence number written is missing. Method 600 thus uses the sequence numbers to determine whether or not data is missing in steps 610 and 640. If there is no missing data (step 610=NO), the mirrored storage may be used (step 620). If the mirrored storage has missing data (step 610=YES), the mirrored storage is quiesced. Quiescing the mirrored storage means that writes of data to the mirrored storage are allowed to complete before processing is stopped on the target system that includes the mirrored storage. Quiescing the mirrored storage will allow missing data to be written in the majority of cases. Thus, if the mirrored storage has no missing data after quiescing the mirrored storage (step 640=NO), the mirrored storage may be used. However, if a failure on the target system will not allow the missing data to be written, quiescing the mirrored storage will not help. In this case, if there is still missing data after the mirrored storage has been quiesced (step 640=YES), the mirrored storage cannot be used (step 650). Note, however, that only a failure on the target system can render the mirrored storage unusable. The mirrored storage only needs to be used when the primary system fails. Thus, the only way for mirrored storage to be unusable is for the primary and target systems to both suffer failures at approximately the same time. Because these systems are geographically remote, the likelihood of the mirrored storage being unusable is extremely small.

The only way to guarantee that mirrored storage is always usable is to enforce the order of writes to the mirrored storage to be identical to the order of writes on the primary storage. This guarantee comes at a very high price in performance. The present invention trades off the vastly improved performance due to asynchronous writes on the target system with the very small chance that the mirrored storage will be unusable due to failures on both the primary system and the target system at the same time.

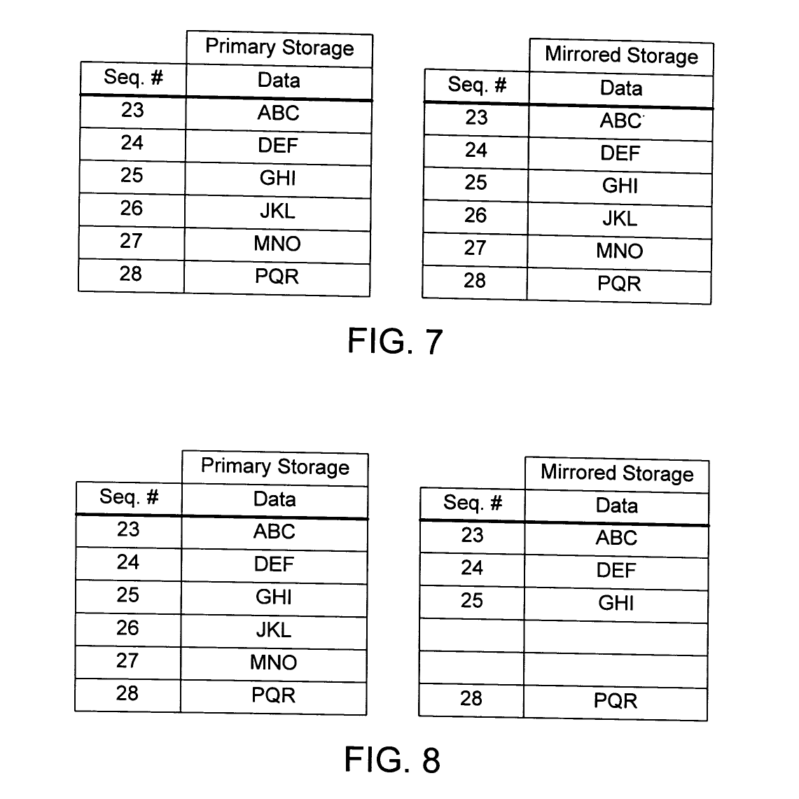

Referring to FIG. 7, we assume that different data in primary storage has been assigned sequence numbers 23-28 for transmission to the mirrored storage. We further assume that the writes of the data corresponding to all sequence numbers 23-28 have been made to the mirrored storage when use of the mirrored storage is required. The sequence number tracking mechanism 540 monitors the sequence numbers of data written to the mirrored storage, and thus knows when data is written out of order. Note that the data in the mirrored storage could be written in any order because the writes occur asynchronously with respect to each other on the target system that includes the mirrored storage. Thus, sequence number 23 could be written first, followed by 25, 24, 28, 26 and 27. Because all the data corresponding to sequence numbers 23-28 have been written to the mirrored storage in FIG. 7, the mirrored storage may be used. From an application point of view, all the data is present, so the writes to mirrored storage appear to have been done in order.

In many cases, even when the computer system that contains the primary storage crashes, the mirrored data is already in the process of being written. As a result, even if data is initially missing in the mirrored storage (step 610=YES in FIG. 6), allowing the mirrored storage to quiesce (step 630) will often result in the missing data being written to the mirrored storage. In this case, all of the primary storage will be reflected on the mirrored storage, as shown in FIG. 7. However, in other cases, a failure on the target computer system that includes the mirrored storage may prevent all of the data from being written to the mirrored storage. Such a case is represented in FIG. 8. We assume in FIG. 8 the same order of writes for the data in FIG. 7, namely 23, 25, 24, 28, 26 and 27. We further assume that a failure in the computer system with the primary storage or a network failure causes the data corresponding to the last two sequence numbers 26 and 27 to not be written to the mirrored storage. This is shown on the right side of FIG. 8, where the data corresponding to sequence number 28 has been written but the data corresponding to sequence numbers 26 and 27 is missing. When use of the mirrored storage is required, the sequence number tracking mechanism will recognize that the data corresponding to sequence numbers 26 and 27 is missing. The sequence number tracking mechanism may attempt to quiesce the mirrored storage, then re-check to see if there is still missing data. If there is still missing data below the highest sequence number written on the mirrored storage after the mirrored storage has been quiesced, the mirrored storage cannot be used. Note, however, that the need to use the mirrored storage only arises due to a failure in the primary system. Furthermore, the only failures that could render the mirrored storage unusable occur on the target system. Thus, for mirrored storage to be unusable when needed, both the primary and target systems would have to fail at approximately the same time. While this is a statistical possibility, the likelihood of this happening is so low that it may never occur in real-life scenarios.

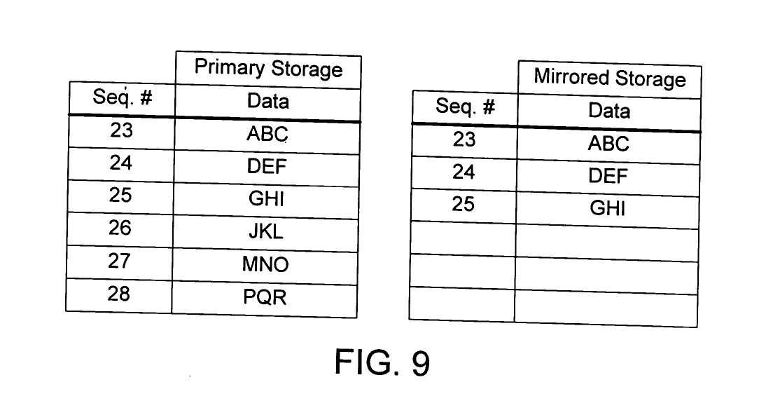

In some cases, the mirrored storage may be used even if all the data was not received as long as there is no data missing that has a sequence number that is less than the highest sequence number of data written to the mirrored storage. This example is shown in FIG. 9. We assume that the mirrored storage includes the data for sequence numbers 23, 24 and 25, but that the data for sequence numbers 26, 27 and 28 is not written, even after quiescing the mirrored storage. In this case, the mirrored storage can still be used even though it has missing data, because there is no missing data with a sequence number less than the highest sequence number of data that was actually written to the mirrored storage. Thus, because sequence number 25 is the highest sequence number of data written to the mirrored storage, and because all data with sequence numbers less than 25 has been written to the mirrored storage, the mirrored storage may be used.

By assigning sequence numbers to data, the data may be logically mirrored in an asynchronous manner. The preferred embodiments thus allow for logical mirroring of data between two geographically remote locations in an asynchronous manner that maximizes speed of the writes between the two, and yet provide a mechanism to easily determine whether the mirrored storage may be used when needed.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. An apparatus comprising:
at least one processor;
a memory coupled to the at least one processor;
primary storage coupled to the at least one processor;
a logical mirroring mechanism residing in the memory and executed by the at least one processor, the logical mirroring mechanism assigning sequence numbers to data stored in the primary storage, writing the data corresponding to the assigned sequence numbers to a mirrored storage, and determining from the assigned sequence numbers whether the mirrored storage has missing data.

2. The apparatus of claim 1 wherein the mirrored storage is in a geographically remote location with respect to the primary storage.

3. The apparatus of claim 1 wherein the mirrored storage is on a different computer system coupled to the apparatus.

4. The apparatus of claim 1 wherein the sequence numbers comprise sequential integers.

5. The apparatus of claim 1 wherein the mirrored storage may be used at a time the mirrored storage is required if the mirrored storage has no missing data corresponding to a sequence number that is lower than the highest sequence number of data written to the mirrored storage.

6. The apparatus of claim 1 wherein the mirrored storage may not be used at a time the mirrored storage is required if the mirrored storage has missing data corresponding to a sequence number that is lower than the highest sequence number of data written to the mirrored storage.

7. A networked computer system comprising:
a first computer system that includes mirrored storage;
a second computer system coupled to the first computer system, the second computer system comprising:
primary storage; and
a logical mirroring mechanism that assigns sequence numbers to data stored in the primary storage, that transfers the data and assigned sequence numbers to the first computer system, that writes the data to the mirrored storage in the first computer system, and that determines from the assigned sequence numbers whether the mirrored storage has missing data.

8. The networked computer system of claim 7 wherein the first computer system is in a location that is geographically remote from the second computer system.

9. The networked computer system of claim 7 wherein the sequence numbers comprise sequential integers.

10. The networked computer system of claim 7 wherein the mirrored storage may be used at a time the mirrored storage is required if the mirrored storage has no missing data corresponding to a sequence number that is lower than the highest sequence number of data written to the mirrored storage.

11. The networked computer system of claim 7 wherein the mirrored storage may not be used at a time the mirrored storage is required if the mirrored storage has missing data corresponding to a sequence number that is lower than the highest sequence number of data written to the mirrored storage.

12. A networked computer system comprising:
a first computer system that includes mirrored storage;
a second computer system in a location that is geographically remote to the first computer system and coupled to the first computer system, the second computer system comprising:
primary storage; and
a logical mirroring mechanism that assigns sequential integer sequence numbers to data stored in the primary storage, that transfers the data and assigned sequence numbers to the first computer system, that writes the data corresponding to the assigned sequence numbers to the mirrored storage in the first computer system, and at a time when use of the mirrored storage is required, determines from the assigned sequence numbers whether the mirrored storage has missing data, and if the mirrored storage has no missing data, using the mirrored storage, and if the mirrored storage has missing data, not using the mirrored storage.

13. A computer-implemented method for mirroring primary storage in a computer system, the method comprising the steps of:
writing data to the primary storage;
assigning a sequence number to the data written to the primary storage;
writing the data corresponding to the assigned sequence number to a mirrored storage; and
determining from the assigned sequence numbers, at a time when use of the mirrored storage is required, whether the mirrored storage has missing data.

14. The method of claim 13 wherein the mirrored storage is in a geographically remote location with respect to the primary storage.

15. The method of claim 13 wherein the mirrored storage is on a different computer system than the primary storage.

16. The method of claim 13 wherein the sequence numbers comprise sequential integers.

17. The method of claim 13 further comprising the step of using the mirrored storage if there is no missing data on the mirrored storage corresponding to a sequence number that is lower than the highest sequence number of data written to the mirrored storage.

18. The method of claim 13 further comprising the step of not using the mirrored storage if there is missing data on the mirrored storage corresponding to a sequence number that is lower than the highest sequence number of data written to the mirrored storage.

19. A computer-implemented method for copying primary storage in a computer system to mirrored storage in a computer system that is located in a geographically remote location with respect to the primary storage, the method comprising the steps of:
writing data to the primary storage;
assigning a sequential integer sequence number to the data written to the primary storage;
transferring the data and assigned sequence number to the computer system that contains the mirrored storage;
writing the data to the mirrored storage;
at a time when use of the mirrored storage is required, determining from the assigned sequence numbers whether the mirrored storage has missing data corresponding to a sequence number that is lower than the highest sequence number of data written to the mirrored storage;
if the mirrored storage has no missing data corresponding to a sequence number that is lower than the highest sequence number of data written to the mirrored storage, using the mirrored storage; and
if the mirrored storage has missing data corresponding to a sequence number that is lower than the highest sequence number of data written to the mirrored storage, not using the mirrored storage.

20. A program product comprising:
a logical mirroring mechanism that assigns sequence numbers to data stored in a primary storage, that writes the data corresponding to the assigned sequence numbers to a mirrored storage, and that determines from the assigned sequence numbers whether the mirrored storage has missing data; and
computer readable signal bearing media bearing the logical mirroring mechanism.

21. The program product of claim 20 wherein the signal bearing media comprises recordable media.

22. The program product of claim 20 wherein the signal bearing media comprises transmission media.

23. The program product of claim 20 wherein the mirrored storage is in a geographically remote location with respect to the primary storage.

24. The program product of claim 20 wherein the mirrored storage is on a different computer system coupled to the apparatus.

25. The program product of claim 20 wherein the sequence numbers comprise sequential integers.

26. The program product of claim 20 wherein the mirrored storage may be used if there is missing data on the mirrored storage corresponding to a sequence number that is lower than the highest sequence number of data written to the mirrored storage.

27. The program product of claim 20 wherein the mirrored storage may not be used if there is missing data on the mirrored storage corresponding to a sequence number that is lower than the highest sequence number of data written to the mirrored storage.

28. A program product comprising:
(A) a logical mirroring mechanism that assigns sequential integer sequence numbers to data stored in a primary storage, that writes the data corresponding to the assigned sequence numbers to a mirrored storage, and that, at a time when use of the mirrored storage is required, determines from the assigned sequence numbers whether the mirrored storage has missing data corresponding to a sequence number that is lower than the highest sequence number of data written to the mirrored storage, and if the mirrored storage has no missing data corresponding to a sequence number that is lower than the highest sequence number of data written to the mirrored storage, using the mirrored storage, and if the mirrored storage has missing data corresponding to a sequence number that is lower than the highest sequence number of data written to the mirrored storage, not using the mirrored storage; and
(B) computer readable signal bearing media bearing the logical mirroring mechanism.

29. The program product of claim 28 wherein the signal bearing media comprises recordable media.

30. The program product of claim 28 wherein the signal bearing media comprises transmission media.
